(19) United States
(12) Patent Application Publication
(10) Pub. No.: US 2007/0139391 A1
(43) Pub. Date: Jun. 21, 2007

(54) Input device

(75) Inventor: Toni Gerhard Bischoff, Petersaurach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/600,969

(22) Filed: Nov. 16, 2006

(30) Foreign Application Priority Data
Nov. 18, 2005 (EP) 05025246.9

(51) Int. Cl. G09G 5/00

(52) U.S. Cl. 345/173

(57) ABSTRACT

In one aspect, an input device having a flexible display and a three-dimensional sensitive layer for acquiring inputs is provided. The flexible display of the input device is advantageously very thin, pliable and energy-saving. The three-dimensional sensitive layer is embedded behind the display means as a 3D touch panel. Inputs on the display means can thus be sensitively identified on a three-dimensional basis, and implemented.

### CROSS REFERENCE TO RELATED APPLICATIONS

This application claims priority of European application No. 05025246.9 EP filed Nov. 18, 2005, which is incorporated by reference herein in its entirety.

### FIELD OF INVENTION

The invention relates to an input device for acquiring inputs.

### BACKGROUND OF INVENTION

Known input devices are used either for acquiring digital inputs (e.g. touch screen, keyboard) or for acquiring analog inputs (e.g. joystick, mouse). The restriction to one of the two input types is disadvantageous for interactive investigations of 3D models (3D: three-dimensional) and/or for controllers of processes. It is not user-friendly for instance to influence speeds and processes or to adjust an object in three dimensions by means of a conventional touch screen.

### SUMMARY OF INVENTION

An object underlying the invention is to realize an input device for digital and analog inputs.

This object is achieved by an input device with a flexible display means and a three-dimensional sensitive layer for acquiring inputs, with the display means being arranged in front of the three-dimensional sensitive layer.

The idea underlying the invention is that a flexible display means is used as a display of an input device and a three-dimensional sensitive layer is used as a touch panel. Such a touch panel is a so-called 3D touch panel, since it is suitable for three-dimensional analog inputs. Since a three-dimensional sensitive layer is usually transparent, the display means is arranged in front of the three-dimensional sensitive layer. An input device of this type thus behaves like a touch screen, which is also suitable for analog inputs. The display options of an input device of this type can be changed without any great effort, as the display means can be easily exchanged.

According to an advantageous embodiment of the invention, the display means is a display which comprises organic light-emitting diodes. Organic light-emitting diodes, also known as OLEDs, are increasingly used as display means. An OLED display is generally made of pliable material. A modem OLED display can be as thin as a plastic film and thereby feature a correspondingly high maneuverability and/or deformability. It requires significantly less energy compared with liquid crystal displays (LCD), causes a background illumination to become redundant and has a large angle of view range and a high switching speed.

In order to improve the tactile feedback to a user, the three-dimensional sensitive layer can be deformed according to a further advantageous embodiment of the invention. Such a layer is made in particular of a soft deformable material (e.g. similar to rigid foam) which can be restored or restores itself into its original state after deformation.

According to a further advantageous embodiment of the invention, the three-dimensional sensitive layer is electrically conductive, with the conductivity of the layer depending on the pressure exerted on the layer. The material of the layer is thus electrically conductive, with its conductivity being changeable in a pressure-sensitive manner. When pressure is exerted on the three-dimensional sensitive layer, a conductive connection appears at this point.

Similarly to conventional touch screens, both matrix and also analog touch panels can be available. This not only allows the usual plan view-oriented 2D inputs, but also allows inputs in the third dimension (by a pressure towards the surface of the panel). This is advantageous in that a speed or a process can be controlled, i.e. analog inputs can be carried out.

As a rule, the necessary function keys, legends and graphics are projected or printed on the OLED display beforehand. Likewise, the corresponding configuration data of the display can be evaluated and stored. Inputs on the display of the input device can thus be identified on a three-dimensional basis and then implemented.

### BRIEF DESCRIPTION OF THE DRAWINGS

The invention is described in more detail below within the scope of an exemplary embodiment with reference to the figures, in which:

FIG. 1: shows an OLED display,

FIG. 2: shows a 3D touch panel,

FIG. 3: shows an input device and

FIG. 4: shows an exemplary application of the input device.

### DETAILED DESCRIPTION OF INVENTION

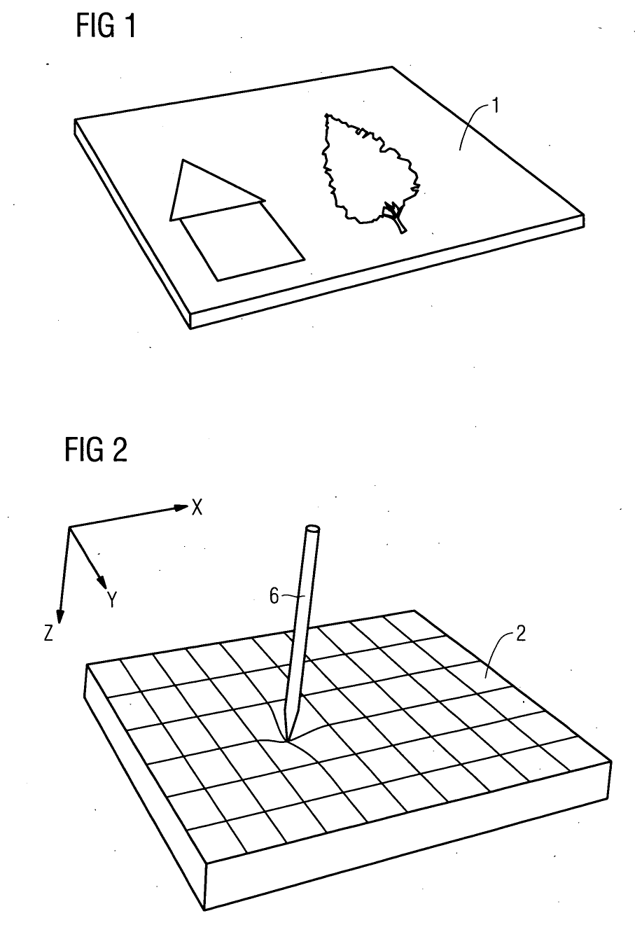

FIG. 1 shows an OLED display 1, which is composed of a carbon layer and is thin and pliable like a plastic film or can be folded in different ways. It is normally arranged between two electrodes. These electrodes produce the electrical field for the light emission.

In addition, the display can be realized by means of a film, whereupon the display layout projects using a laser.

FIG. 2 shows a 3D touch panel 2, which is suitable for 3D inputs. With this touch panel, thin lines (line bars) are etched into the front layer, so that a number of columns and likewise rows in the horizontal direction are generated, thereby finally resulting in a matrix touch panel. If pressure is exerted on the touch panel, e.g. using the input pen 6, an electrical contact is recorded and a potential gradient is first generated in two dimensions in the front layer by way of a line bar, with the resistance and/or the capacity of the touch panel changing with the increasing pressure, which in turn triggers a specific voltage. This is dependent on where the contact takes place on the horizontal axis. A 3D touch panel of this type not only allows the position (X/Y dimensions) on the 3D touch panel, where an input is implemented, to be determined, but also allows the intensity of the pressure, which takes place when making the entry at the position, to be detected (Z-dimension).

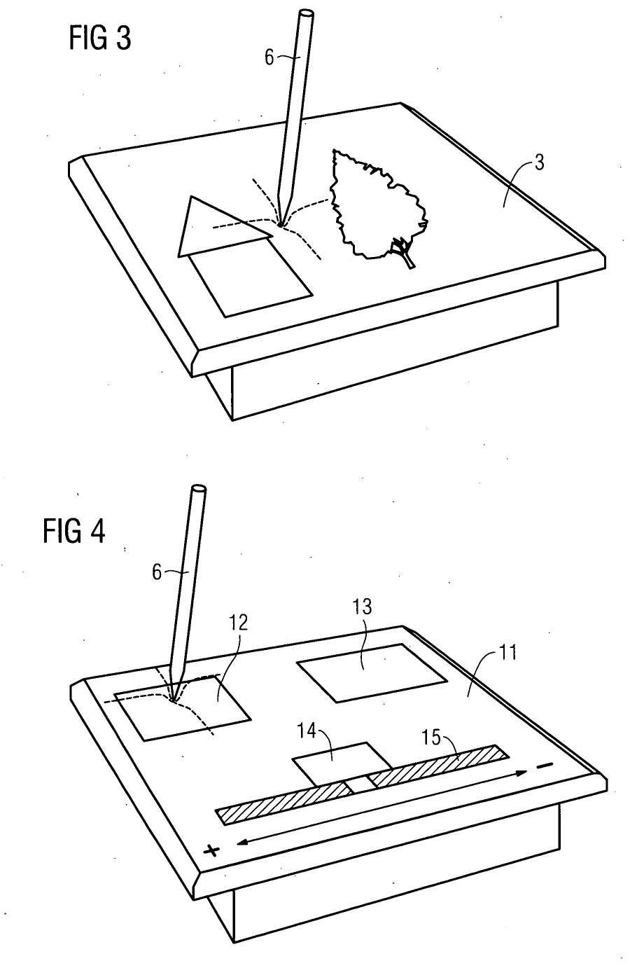

As the 3D touch panel is opaque and an OLED display is thin and pliable, the OLED display is placed in front of the 3D touch panel (FIG. 3). An input device 3 designed in this way allows the operating position/input position to be determined as with a conventional touch screen, along with the position depth (pressure strength). In other words, with the corresponding software this results in a specific function being triggered. The touch screen is hereby suitable for 3D inputs.

Furthermore, a digital and an analog function can be separately evaluated and simultaneously controlled by means of the input device, with each function using position-oriented parameters and/or parameters relating to position depth.

FIG. 4 illustrates an input device as an exemplary application, with a slider 14 being able to be controlled on an axis 15 by means of this input device. Two keys 12, 13 are visible on the display 11, said keys assigning the functions for moving the slider 14 in two directions in each case. Here the key 12 is responsible for the movement in the direction “+”, whilst the key 13 is responsible for the direction “−”. The displacement speed of the slider 14 is additionally influenced by the pressure intensity on the keys 12, 13. If a user holds an input pen 6 on the key 12 on the display, the slider 12 is moved in direction “+”. The user can then speed up the movement of the slider 12 using a pressure towards the surface of the display (Z-dimension). The harder he/she presses key 12, the faster the slider 14 moves. During the control, digital information is given for instance for the movement direction of the axis and analog information for the speed of the axis.

At the same time, a perspective simulation of the slider 4 and of the axis 5 can be graphically demonstrated on the display 1.

In summary, the invention thus relates to an input device with a flexible display means and a three-dimensional sensitive layer for acquiring inputs. The display means of the input device is advantageously very thin, pliable and energy-saving. The three-dimensional sensitive layer is embedded behind the display means as a 3D touch panel. Inputs on the display means can thus be sensitively identified on a three-dimensional basis and implemented.

1-4. (canceled)

5. An input device for acquiring analog and digital input, comprising:
a three-dimensional sensitive layer for acquiring inputs; and
a flexible display arranged in front of the three-dimensional sensitive layer.

6. The input device as claimed in claim 5,
wherein the three-dimensional sensitive layer is electrically conductive, and
wherein the conductivity of the layer is based on a pressure exerted on the layer.

7. The input device as claimed in claim 5, wherein the three-dimensional sensitive layer is deformable.

8. The input device as claimed in claim 5, wherein the display comprises organic light-emitting diodes.

9. The input device as claimed in claim 8, wherein the three-dimensional sensitive layer is deformable.

10. The input device as claimed in claim 9, wherein the three-dimensional sensitive layer is electrically conductive, and wherein the conductivity of the layer is based on a pressure exerted on the layer.

11. An input device for acquiring analog and digital input, comprising:
a three-dimensional sensitive layer for acquiring inputs;
a flexible display arranged in front of the three-dimensional sensitive layer; and
a plurality of organic light-emitting diodes arranged in the flexible display.

12. The input device as claimed in claim 11,
wherein the three-dimensional sensitive layer is electrically conductive, and
wherein the conductivity of the layer is based on a pressure exerted on the layer.
